(19) United States
(12) Patent Application Publication
(10) Pub. No.: US 2025/0209097 A1
(43) Pub. Date: Jun. 26, 2025

(54) DATA CONTROLS USING PROMPT PROCESSING UNITS

(71) Applicant: Cisco Technology, Inc., San Jose, CA (US)

(72) Inventors: Marcelo Yannuzzi, Nuvilly (CH); Benjamin William Ryder, Lausanne (CH); Chiara Troiani, Cheseaux-sur-Lausanne (CH); Franck Bachet, Breval (FR); Jean Andrei Diaconu, Gaillard (FR); Hervé Muyal, Gland (CH)

(73) Assignee: Cisco Technology, Inc., San Jose, CA (US)

(21) Appl. No.: 18/933,351

(22) Filed: Oct. 31, 2024

Related U.S. Application Data
(60) Provisional application No. 63/613,863, filed on Dec. 22, 2023.

(51) Int. Cl. G06F 16/332; G06F 21/62

(52) U.S. Cl. CPC G06F 16/3329; G06F 21/6218

(57) ABSTRACT

In one implementation, a device may identify features of a prompt to be sent to a language model that are indicative of a type of data that the prompt would cause the language model to access. The device may determine whether data control policies apply for the prompt based on the type of data that the prompt would cause the language model to access. The device may determine, based on the features, whether processing of the prompt by the language model violates an applicable data control policy. The device may prevent the language model from processing the prompt when the processing of the prompt violates the applicable data control policy.

### RELATED APPLICATION

This application claims priority to U.S. Prov. Appl. Ser. No. 63/613,863, filed Dec. 22, 2023, for DATA CONTROLS USING PROMPT PROCESSING UNITS, by Yannuzzi, et al., the contents of which are incorporated herein by reference.

### TECHNICAL FIELD

The present disclosure relates generally to computer networks, and, more particularly, to data controls using prompt processing units.

### BACKGROUND

Although many enterprises aim to leverage generative artificial intelligence (AI), there is a competing aim to retain control of what data is sent, used, and returned by these third-party systems. For example, enterprises are faced with the necessity of preventing unauthorized input of sensitive data (e.g., personally identifiable information (PII), sensitive customer-data, code, blueprints, trade secrets, etc.), preventing the misuse of sensitive data (e.g., infringing consented purpose of use and/or corporate's Data Minimization Rules (DMRs)), and/or preventing model manipulation to gain access to sensitive data.

Generative AI poses new challenges in this regard, rendering previous data security approaches ineffective. For instance, even though current models and agents can “interpret” open-ended prompts and act upon them-by generating artifacts or executing various tasks based on such “understanding”-this skill is not accessible to the enterprise. This lack of understanding and natural-language native techniques hinders the possibility to apply effective controls on the data before the prompts are processed by external entities. As a result, existing techniques fall short in preventing sensitive data leakage and corporate policy violations.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example of an architecture for sending prompts to a remote language model;

FIG. 4 illustrates an example of an architecture utilizing prompt processing units;

FIGS. 5A-5B illustrate an example of a data control system leveraging prompt processing unit outputs;

FIGS. 6A-6B illustrate an example of a data control system;

FIGS. 7A-7B illustrate an example of a data control system with customized policy matrices;

FIGS. 8A-8B illustrate an example of a data control system with a prompt processing unit working in tandem with data controls; and

FIG. 9 illustrates an example of a simplified procedure for PPU-based data controls, in accordance with one or more implementations described herein.

### DESCRIPTION OF EXAMPLE IMPLEMENTATIONS

### Overview

According to one or more implementations of the disclosure, a device may identify features of a prompt to be sent to a language model that are indicative of a type of data that the prompt would cause the language model to access. The device may determine whether data control policies apply for the prompt based on the type of data that the prompt would cause the language model to access. The device may determine, based on the features, whether processing of the prompt by the language model violates an applicable data control policy. The device may prevent the language model from processing the prompt when the processing of the prompt violates the applicable data control policy.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

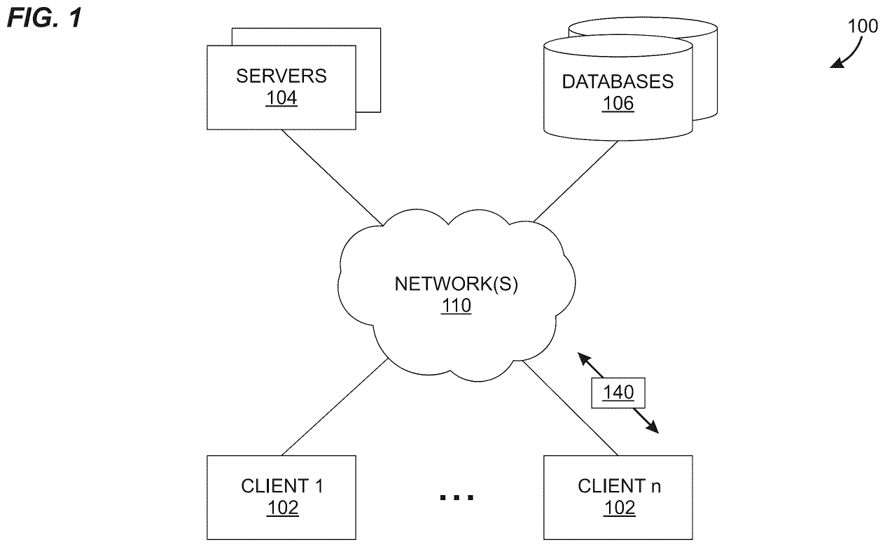

FIG. 1 is a schematic block diagram of an example simplified computing system (e.g., computing system 100) illustratively comprising any number of client devices (e.g., client devices 102 with, e.g., a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, servers 104 and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

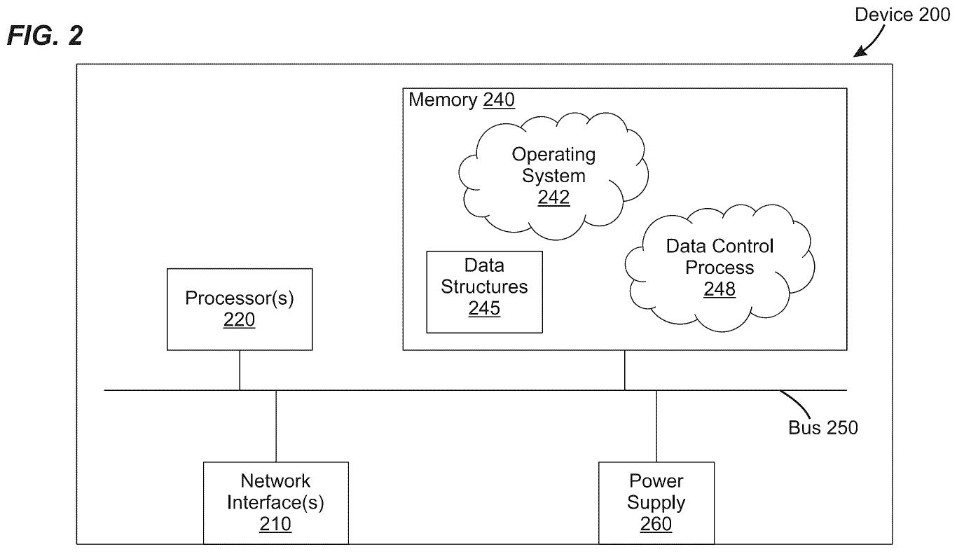

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processes and/or services executing on the device. These software processes and/or services may comprise one or more functional processes, and on certain devices, a data control process 248, as described herein. Notably, the functional processes, when executed by processor(s) 220, may cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, data control process 248 may include computer executable instructions that, when executed by processor(s) 220, cause device 200 to perform the techniques described herein. For example, data control process 248 may include computer-executable instructions stored on a computer-readable medium that are executable by processor(s) 220 to cause node/device 200 to perform a portion of a PPU-based data control operation.

To do so, in some implementations, data control process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, data control process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that data control process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, data control process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, data control process 248 may use a generative model to generate synthetic network traffic based on existing user traffic to test how the network reacts. Example generative approaches can include, but are not limited to, generative adversarial networks (GANs), foundation models such as large language models (LLMs), other transformer models, and the like.

As noted above, the increased use of generative AI is posing new challenges to enterprises with respect to data control. More specifically, enterprises need mechanisms that can prevent unauthorized input of sensitive data, the misuse of sensitive data, and/or model manipulation to gain access to sensitive data when utilizing generative AI. Indeed, existing techniques fall short in preventing sensitive data leakage and enterprise policy violations with generative AI given that sensitive information may be referenced, used, and/or extracted indirectly (i.e., without explicitly being part of a query).

Further, sensitive information is often needed to complete a task, so personally identifiable information (PII) masking or redaction techniques may not work. In fact, in many cases, it is possible to use model-based analysis to detect the source even after masking or redacting PII. Furthermore, sensitive information may be misused (e.g., for a secondary purpose not compliant with consented purpose of use or by infringing Data Minimization Rules (DMRs)). For instance, specific enterprise controls are often not covered by masking filters and/or redaction techniques. It makes little sense to apply pattern matching controls, such as regular expressions (regex), Exact Data Matching (EDM), or Indexed Document Matching (IDM) techniques to next generation natural language-based systems.

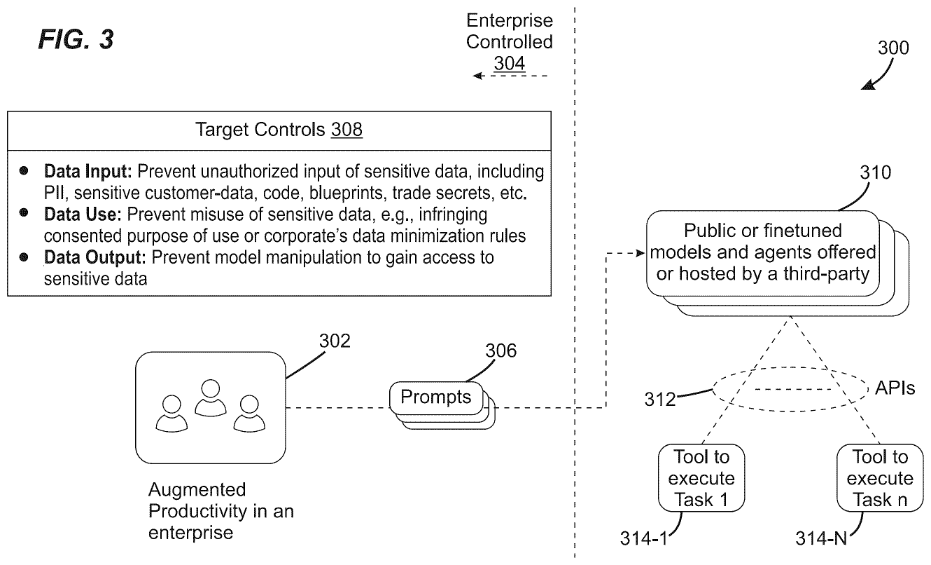

FIG. 3 illustrates an example of an architecture for sending prompts to a remote language model, in various implementations. In architecture 300, users 302 in an enterprise-controlled network 304 may send prompts 306 (e.g., queries, etc.) to an external machine learning model (e.g., machine learning model 310). Typically, machine learning model 310 may be a public or finetuned language model, such as an LLM, or any other generative AI model configured to process the prompts 306. For example, users 302 such as sales, marketing, customer support, data analytics, engineering, product management, or other personnel in the enterprise may utilize prompts 306 to enhance their productivity.

Typically, prompts 306 may be generated based on input directly from users 302, such as via a chatbot assistant. However, further implementations provide for the use of other programmatic approaches to generate prompts 306, such as by a user selecting a button within a user interface and the underlying program generating a prompt, or the like. In some instances, the executing program may send prompts 306 to machine learning model 310 via one or more application programming interfaces (APIs) and present the results to users 302, accordingly.

During processing of any of prompts 306, machine learning model 310 may itself leverage one or more APIs 312 to interact with a set of tools 314 (e.g., a first tool 314-1 through nth tool 314-n) to perform any number of discrete tasks. For instance, the set of tools 314 may allow machine learning model 310 to retrieve information from a certain source, as part of its processing. More complex approaches also provide for the set of tools 314 allowing machine learning model 310 to exert some control over an underlying system or device.

Also as shown, from the perspective of the enterprise, there may be a set of targeted controls 308 that the enterprise desires, such as any or all of the following:
Data input—e.g., preventing the unauthorized input of sensitive data, including PII, customer data, code, blueprints, trade secrets, etc.
Data use—e.g., prevent misuse of sensitive data, such as infringing a consented purpose of use or the data minimization rules of the entity
Data output—e.g., preventing manipulation of machine learning model 310 to gain access to the sensitive data

While many online machine learning models (e.g., ChatGPT, etc.) today are able to interpret open-ended prompts and act upon them by generating artifacts based on such understanding, this skill is also not accessible to the enterprise itself. This lack of skill hinders the ability to effectively implement all of the additional controls (e.g., set of targeted controls 308) listed above on the data, before prompts 306 are sent to an external entity from that of the enterprise.

### Data Controls Using Prompt Processing Units

In contrast, the techniques herein facilitate LLM processing through the use of prompt processing units (PPUs). These techniques facilitate the characterization and distillation of key features from a prompt in a systematic manner. These characterizations may then be leveraged in data control techniques to prevent sensitive data leakage and/or enterprise policy violations.

For instance, these techniques may be leveraged by an enterprise to define, apply, and manage rules enabling data controls working in tandem with a PPU, with focus on controlling sensitive data processing, data leakage and misuse. Moreover, the techniques may be leveraged to detect infringements to such rules in real-time, by applying targeted search (e.g., similarity search) in a confined space, including infringements to consented purpose of use of the data, DMRs, relative geo-location between the client and the data processor (e.g., the LLM instance), output data transfer, and retrieval of augmented context before a prompt is sent to a third party. These techniques may be applied at inference time, during few-shot prompting, and/or during fine tuning processes.

Illustratively, the techniques described herein may be performed by hardware, software, and/or firmware, such as in accordance with data control process 248, which may include computer executable instructions executed by the processor(s) 220 (or independent processor of the network interfaces 210) to perform functions relating to the techniques described herein.

Specifically, according to various implementations, a device may identify features of a prompt to be sent to a language model that are indicative of a type of data that the prompt would cause the language model to access. The device may determine whether data control policies apply for the prompt based on the type of data that the prompt would cause the language model to access. The device may determine, based on the features, whether processing of the prompt by the language model violates an applicable data control policy. The device may prevent the language model from processing the prompt when the processing of the prompt violates the applicable data control policy.

Operationally, the techniques herein introduce a modification to architectures such as architecture 300, to also use what are referred to as prompt processing units (PPUs). Such a system may be utilized to characterize and distill key features from prompts 306 in a systematic manner. These characterizations may then be leveraged in data control techniques to prevent sensitive data leakage and/or enterprise policy violations, facilitating vestiture of additional controls (e.g., set of targeted controls 308) with the purview of an enterprise.

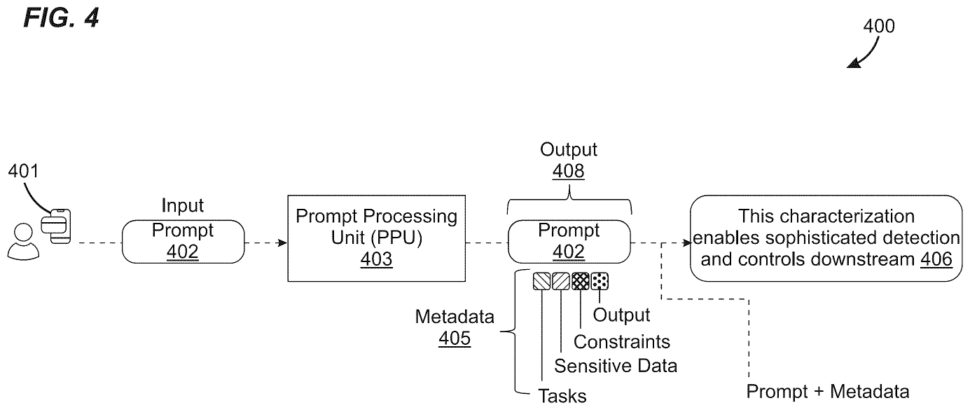

FIG. 4 illustrates an example of an architecture 400 utilizing PPUs, according to various implementations. In some instances, architecture 400 may be a portion of a data control system that leverages the outputs of PPUs to institute downstream data controls.

As shown, architecture 400 includes a prompt processing unit (PPU 403). A PPU 403 may be a highly efficient processing element that may receive a prompt 402 as an input (e.g., from a user chat interface or an API 401). PPU 403 may parse the query and/or may detect a set of key features from the query. For instance, PPU 403 may detect key features within the prompt 402 such as the tasks requested, the sensitive data entailed to complete the tasks, any constraints applicable to complete the tasks, and/or the desired output upon completion of such tasks.

A PPU 403 may act as a transparent element, delivering the unmodified prompt 404 augmented with metadata 405 carrying the key features, such as those described above. More specifically, a PPU 403 may systematically distill and characterize prompts, allowing for downstream controls 406 to be applied.

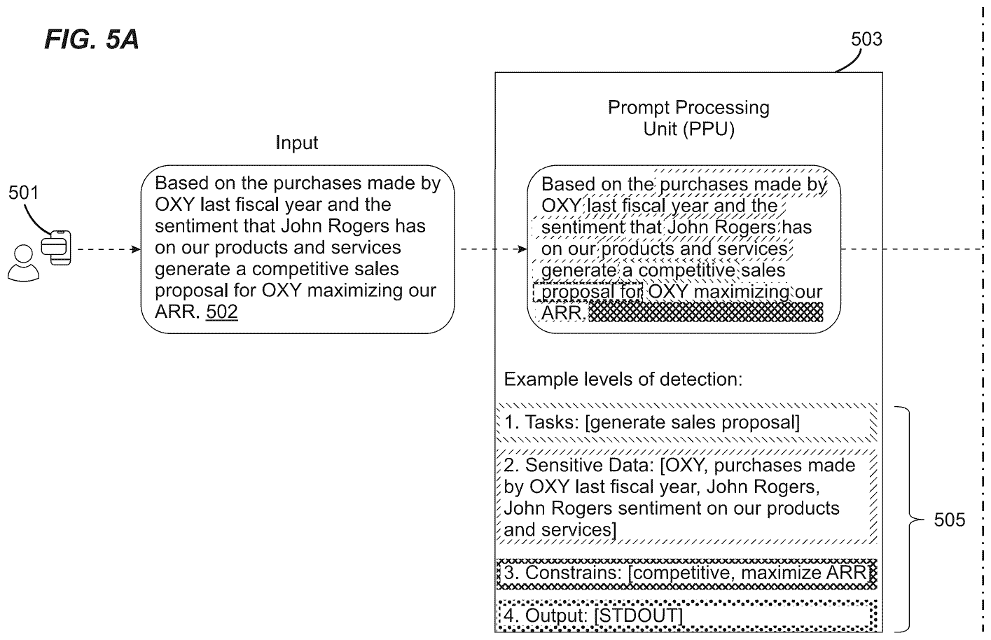

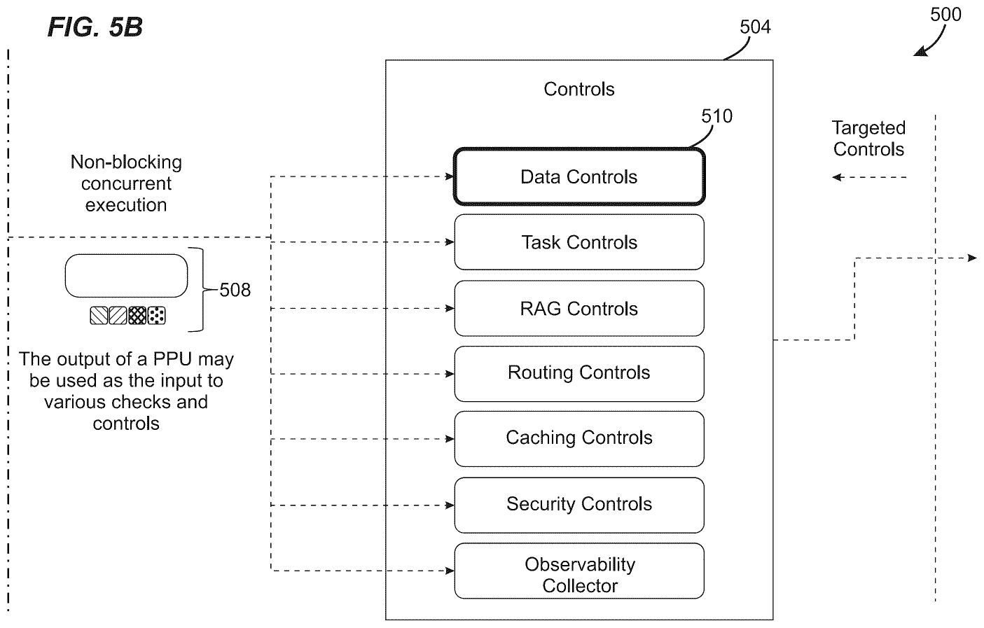

FIGS. 5A-5B illustrate an example of a data control system 500 that leverages the outputs of PPUs. In data control system 500, an input prompt 502 (e.g., sent by a user in the sales department either using a chat interface or an API 501) may be processed by PPU 503. PPU 503 may detect key features in the input prompt 502 such as those outlined above. These features and/or other characterizing data may be packaged as metadata 505.

PPU 503 may generate an output 508 that makes available the prompt along with the prompt characterization (e.g., metadata 505) to various processes downstream. In various implementations, PPU 503 may fan-out the prompt and the corresponding metadata (e.g., output 508) to various controls (e.g., controls 504). These controls 504 may process the output of PPU 503 concurrently and in a non-blocking manner before the prompt is sent to any external entity. One such example of controls 504 includes data controls module 510, which may be applied before input prompt 502 is processed by external entities.

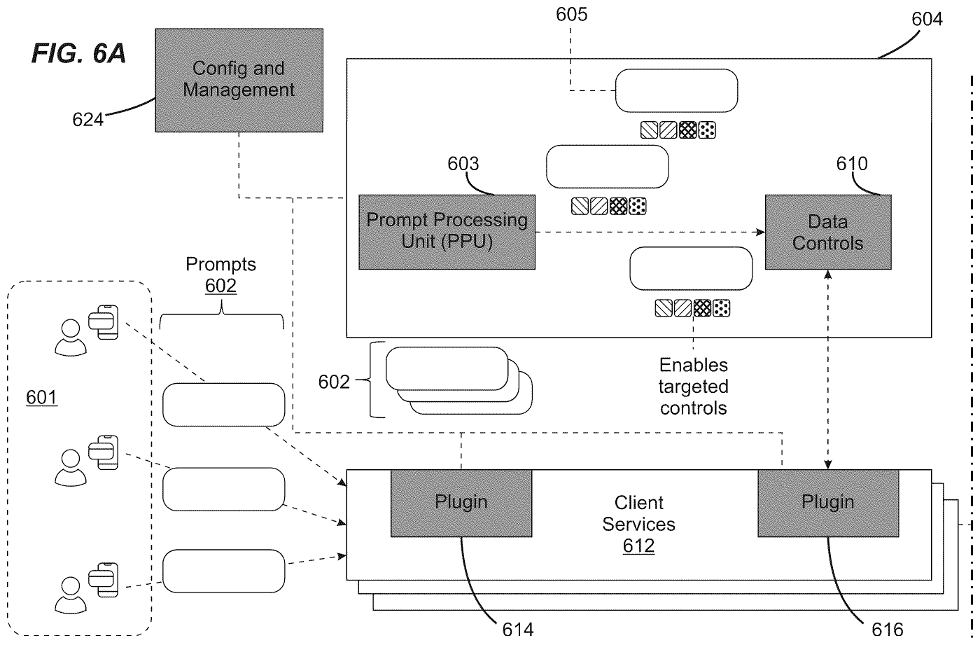

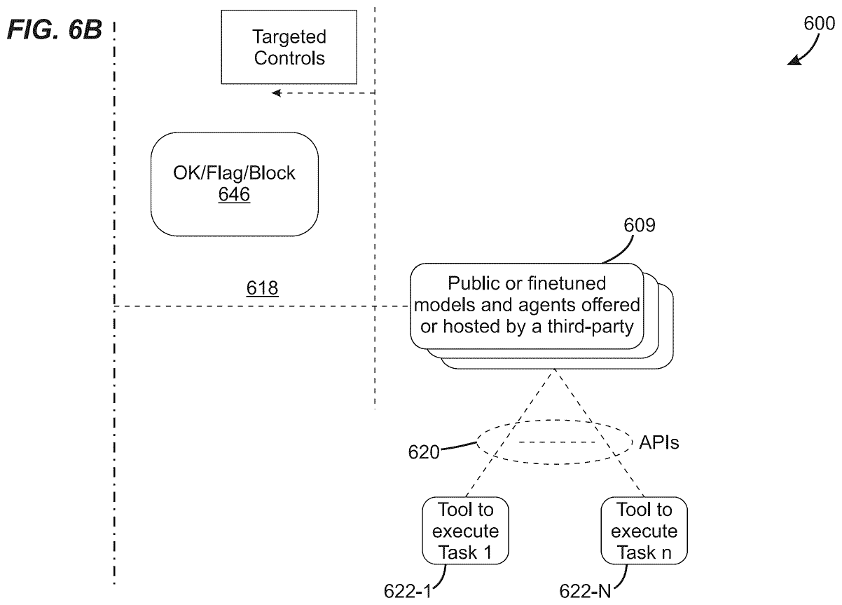

FIGS. 6A-6B illustrate an example of a data control system 600 involving distributed prompt processing. In data control system 600, various users and/or APIs 601 may send prompts 602 to potentially different models and/or agents 609 offered or hosted by third parties.

Various methods may be used to retain and exercise control before the prompts are sent to external entities. For example, an intermediate layer of control may be utilized, such as an API Gateway, other gateways, an inference system, a data governance tool, a data loss prevention (DLP) tool, a service in partnership with model or agent providers or servers, an API Hub, etc. Any of these intermediate elements of control may act as a client service 612 working in concert with element 604, which may comprise PPU 603 and data controls 610 working in tandem.

PPU 603 may interface with client service 612 through plugin 614, which may be used to efficiently redirect the prompts to PPU 603 along with additional metadata. Such metadata may comprise the user ID, the tenant ID, and the App ID (e.g., identified through the API key used) associated to the various users of client service 612. In some implementations, such metadata might be sent by client service 612 directly to the corresponding controllers, e.g., data controls 610 in this case, thereby bypassing PPU 603.

Example client services 612 may include, but are not limited to, any or all of the following:
An API gateway (e.g., Kong)
3^{rd} party inference systems (e.g., MosaicML)
3^{rd} party data governance tools
3^{rd} party DLP tools
A service in partnership with model providers or servers
An API hub
Future inference systems
etc.

The PPU 603 may provide the prompt along with the prompt characterization (e.g., metadata 605) to data controls 610. This may facilitate targeted downstream controls.

The processing made by data controls 610 may result in the output 646, where each prompt may successfully pass controls such as the controls (OK), be flagged, or blocked. The distinction of whether to flag or block the prompt may depend on which is the desired point of policy enforcement. For instance, in some cases client service 612 may want to retain control, perhaps reengineer the prompt, or block it. In other cases, a client service 612 may rely on data controls 610 to that end. The output 646 may be received at client service 612 through plugin 616. In some cases, plugins 614 and 616 may be unified.

The prompts that successfully passed the checks and controls implemented by data controls 610 may be sent (e.g., at box 618) to the various public or finetuned models and/or agents 609 offered or hosted by third parties. Such models may be part of larger systems, which may use various APIs 620 and tools 622 (e.g., 622-1 . . . 622-N) to orchestrate, execute, and chain various tasks before responding to a query carried in a prompt.

In addition, a configuration and management module 624 may manage PPU 603, data controls 610 as well as plugin 614 and plugin 616. In some implementations, one or more plugins may be used. For example, one or more of the plugin 614 may be used to handle various PPUs concurrently, to potentially distribute the load across users, tenants, and/or applications, and/or to ensure isolation among them.

Additionally, or alternatively, the PPUs might be specialized elements, which may distill different properties from a prompt depending on the use case (e.g., sales, healthcare, finance, etc.). Hence, various plugins, like plugin 614, may be used to segment and redirect prompts to the correct PPUs. In addition, a plugin like plugin 616 may support a mechanism to indicate the need to reengineer the prompt, block it, and/or send feedback about the result to the corresponding user or process that issued the prompt.

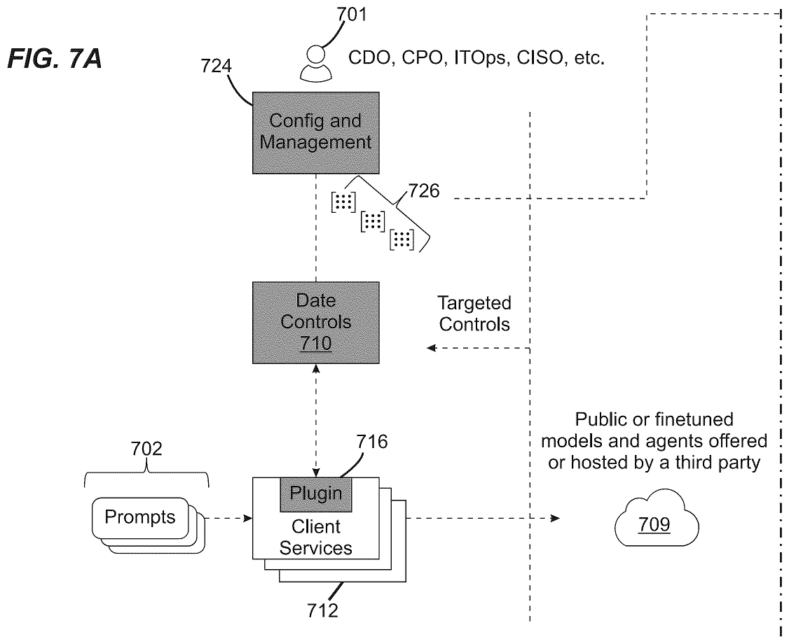

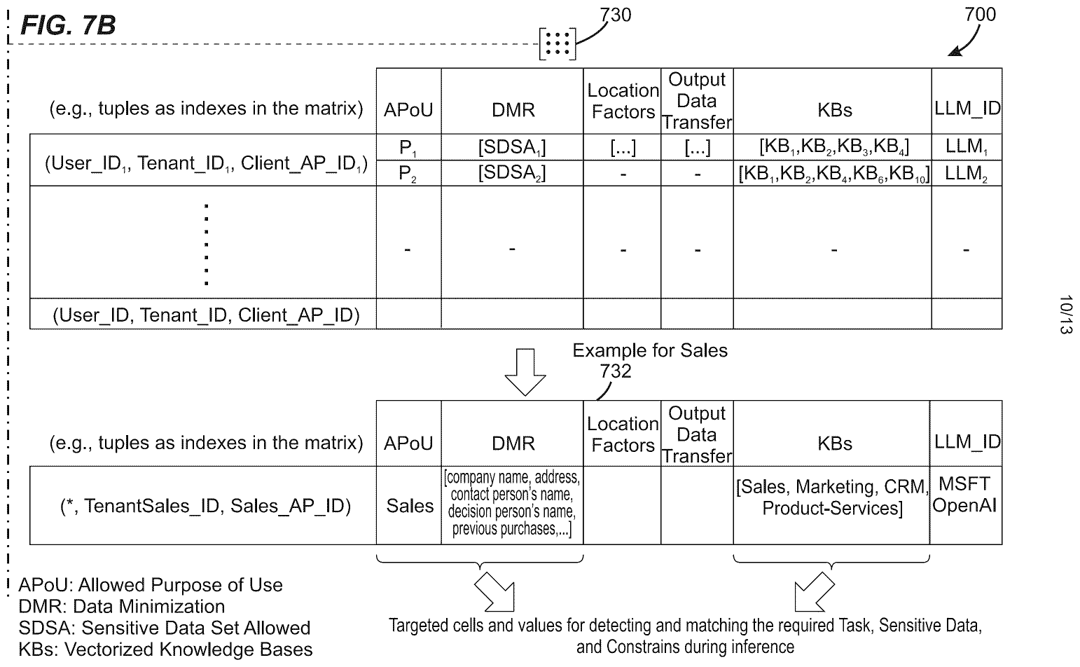

FIGS. 7A-7B illustrates an example of a data control system 700 with customized policy matrices. In various implementations, an administrator 701 may define policy by creating a set of rules in configuration and management module 724. Such rules may be captured in a set of policy matrices 726, which may be pushed to data controls 710. The set of policy matrices 726 may be enforced by the latter using plugin 716 on client services 712. Client services 712 may pass prompts 702 to public or finetuned models and/or agents 709 offered or hosted by third parties in accordance with the set of policy matrices 726.

Several policy matrices (e.g., set of policy matrices 726) may be pushed to data controls 710, and several data controls 710 instances may be allocated (e.g., one per each client service of client services 712). Each of the set of policy matrices 726 may facilitate granular policy definition and controls. For instance, they may bring together user IDs, tenant IDs, client App IDs, sensitive data controls, and augmented context retrieval from chosen knowledge bases (KBs). Further, they may facilitate controls on consented purpose of use, corporate data minimization rules, rightful LLM processor, geo-location factors, as well as controls on output data transfers.

The functionality of data controls 710 may cover the detection of data control policy infringements to each of the set of policy matrices 726 during inference in real-time, by working in tandem with a PPU. They may also cover the detection of data control policy infringements to the data stored in retrieval augmented generation (RAG) KBs themselves. In addition, the functionality of data controls 710 may cover the detection of data control policy infringements to the data retrieved during the use of RAG KBs, as well as during few-shot prompting and fine-tuning. It may also include asynchronous checks over RAG KBs as they might be frequently updated. In addition, data controls 710 may follow an open integration model capable of plugin to an open ecosystem of tools (e.g., Kong, DLP tools, auditing tools, model providers, etc.).

Matrix 730 illustrates an example implementation of a policy matrix. The policy matrix may be a generic policy matrix including dedicated cells for: allowed purpose of use (APOU) (e.g., consistent with consented purpose of use); data minimization rules (DMR) including sensitive data set allowed (SDSA) as compact sets complying with DMRs; location factors (e.g., covering the relative location between end users or App instances, data controllers and data processors, such as an LLM); output data transfers (e.g., compliant receptors, addressees, and/or destinations where to send the output to); vectorized knowledge bases (KBs) allowed to be used and/or rightful/lawful models (e.g., LLMs) and/or agents that may be used.

Matrix 732 illustrates a concrete example of matrix for the case or sales. As illustrated, tuples comprising elements, such as User_ID, Tenant_ID, and Client_AP_ID may be used as indexes in matrix 732.

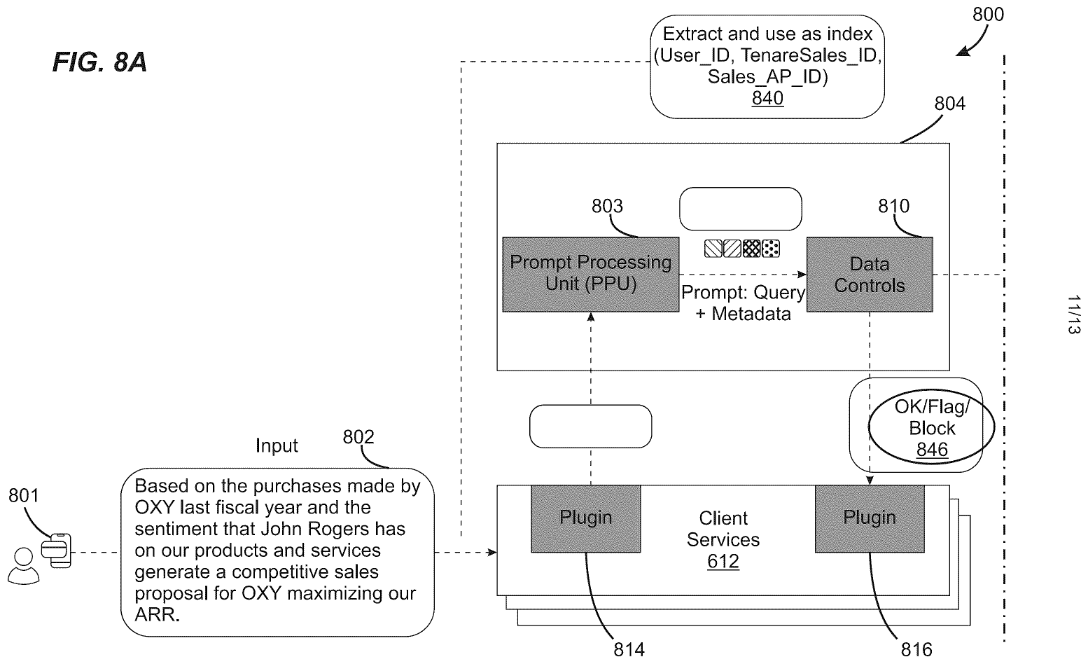

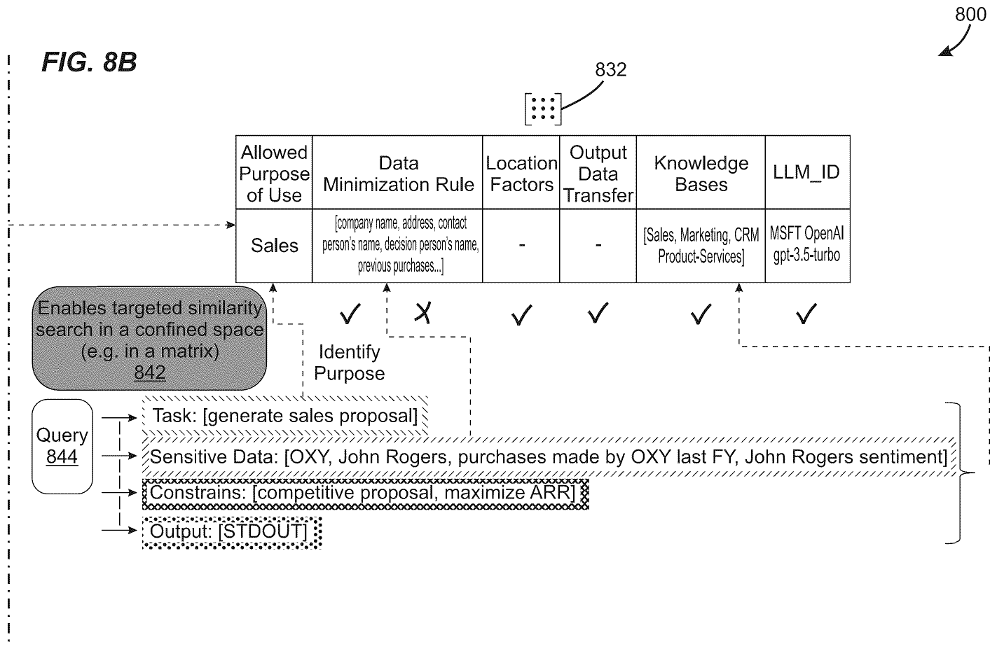

FIGS. 8A-8B illustrates an example of a data control system 800 with a PPU 803 working in tandem with data controls 810. A client service 812 may receive an input prompt 802 from a chat interface or an API 801. This may be a chat interface, or an API 801 utilized by, for example, an enterprise's sales department. PPU 803 may interface with client service 812 through plugin 814, which may be used to efficiently redirect the prompts to PPU 803. PPU 803 may distill the key features from input prompt 802 in the form of query 844.

As described above, either PPU 803 or data controls 810 of element 804 may receive additional metadata from client service 812. This additional metadata may include the user ID, the tenant ID, and the App ID associated to the user/process that sent query 844 to client service 812 as part of input prompt 802. Such metadata may be forwarded to data controls 810. Data controls 810 may, in turn, utilize this information (e.g., in box 840) as an index to identify the corresponding policy matrix 832 and to identify the specific row that should be searched for, in order to check for, and apply the data controls defined by an administrator (e.g., an administrator may define policy by creating a set of rules in configuration and management module 724 as outlined in FIGS. 7A-7B).

Data controls 810 may be empowered by model-based inspection and detection. That is, data controls 810 instances may enable the targeted search (e.g., the similarity search in box 842) in a confined space in the cells within a policy matrix. The term confined may refer to the fields that compose the various entries in a cell within a matrix being limited in scope, and therefore, the dictionary and type of words used in the policy definitions is bounded (i.e., it may not be open-ended).

The different elements in the characterization of query 844 may drive the search (e.g., the similarity search performed in box 842). For example, the similarity search may be targeted to, among other things, identifying a policy violation to the data minimization rule defined at corporate level, since, in the example in FIGS. 8A-8B, sentiment analysis shouldn't be used as part of the request per the policy. This might be flagged to client service 812, using plugin 816 in box 846.

Various flags might be used depending on the severity of the data control policy infringement detected. For instance, sentiment analysis might be flagged because of a corporate policy stating that it shouldn't be used (e.g., due to poor accuracy/reliability), or because the person/entity has not opted in for such analysis, and therefore, it's use is not compliant with regulations, or other factors.

In various implementations, components of the data control system 800 may be operable to facilitate dynamic control (e.g., selectively apply, disable, bypass, etc.) of data controls 810. For example, the characterization provided by the PPU 803 may be leveraged to dynamically activate data controls 810. For instance, if PPU 803 detects that data is required to complete the task carried in an input prompt 802 and/or query 844, then data controls 810 may be activated. On the contrary, if no data is required, then data controls 810 may be partially or fully disabled, bypassed, etc.

This capacity to selectively adapt the prompt processing pipeline and controls applied in data control system 800 based on the contents of the input prompt 802 may avoid processing every prompt as though data controls 810 will be applied regardless of its contents. This can provide substantial resource savings (e.g., computational resources, energy resources, time, cost, infrastructure, etc.) without compromising the quality and reliability of data control application. For instance, leveraging the characterization already performed by PPU 803 can avoid delays and resource consumption spent in needlessly scanning the policy matrices for every prompt.

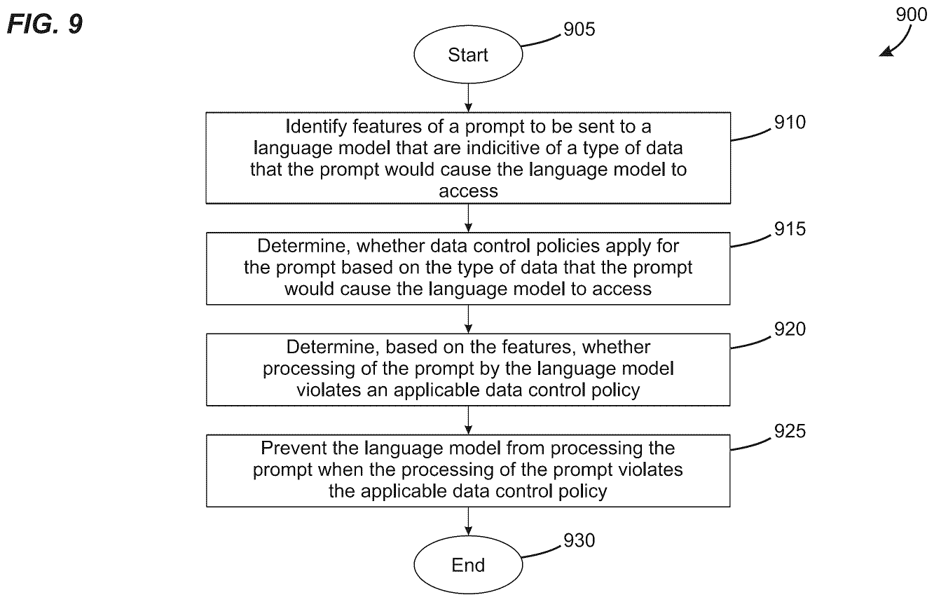

FIG. 9 illustrates an example of a simplified procedure for PPU-based data controls, in accordance with one or more implementations described herein. For example, a non-generic, specifically configured device (e.g., device 200), may perform procedure 900 (e.g., a method) by executing stored instructions (e.g., data control process 248).

The procedure 900 may start at step 905, and continues to step 910, where, as described in greater detail above, the device (e.g., a controller, processor, etc.) may identify features of a prompt to be sent to a language model. The features may be features indicative of one or more of a task requested in the prompt, a type of data that the prompt would cause the language model to access, a constraint applicable to completing the task, and/or an expected output on completion of the task.

In various implementations, the prompt may be parsed to automatically identify the features of the prompt (e.g., via a PPU). The features of the prompt may be provided as metadata associated with the prompt. The features may be configured and provided for comparison to data control polices (e.g., to perform similarity searches to identify applicable data control policies and/or identify applicable data control policy violations).

At step 915, as detailed above, a device may determine whether data control policies apply for the prompt based on the type of data that the prompt would cause the language model to access. That is, in various implementations, the data controls may be activated dynamically. For example, if operations by a PPU result in a determination that data is required to complete the task carried in a query/prompt, then data controls may be applied. Alternatively, if no data is required, then data controls may not be applied. Therefore, a prompt processing pipeline and controls may be selectively applied based on the contents of the prompt. In contrast to an “all or nothing” approach that requires scanning of data control matrices for every prompt, the selective identification and application of data controls leveraging the characterization already performed by PPU can dramatically reduce the delay and time spent in the prompt processing pipeline.

At step 920, as detailed above, a device may determine, based on the features, whether processing of the prompt by the language model violates an applicable data control policy. In various implementations, data control policies applicable to the prompt may be identified. This identification may be performed based on a determination that the data control policies apply for the prompt (e.g., based on the type of data that the prompt would cause the language model to access). The data control policies applicable to the prompt may be identified based on the identified features of the prompt.

For example, the data control policies applicable to the prompt may be identified by a search (e.g., similarity search) of a repository of data control policy matrices for a data control policy that corresponds to the features of the prompt. In some instances, the data control policies applicable to the prompt may be identified by their correspondence to an identification associated with a submitter of the prompt. For example, data control permissions or policies applicable to a particular user, particular user identification, and/or particular type of user may be identified and/or applied based on the identification associated with the submitter of the prompt.

Determining whether processing of the prompt by the language model violates an applicable data control policy may be achieved by comparing the data control permissions and/or policies applicable to a user to the features of the prompt to determine if any of the features represent a data control policy violation. Control over the prompt may be retained by an intermediate layer while determining whether the processing of the prompt by the language model violates the applicable data control policy and/or prior to its release to an external entity upon finding that it does not violate the applicable data control policy.

At step 925, as detailed above, the device may prevent the language model from processing the prompt when the processing of the prompt violates the applicable data control policy. Preventing the language model from processing the prompt may include blocking the prompt from being provided to the language model for processing. In some instances, preventing the language model from processing the prompt may include filtering a portion of the prompt from being provided to the language model for processing. In various implementations, preventing the language model from processing the prompt may include flagging the prompt for reengineering prior to being provided to the language model for processing. Violations may additionally be logged and/or utilized to characterize violation patterns.

Alternatively, or additionally, procedure 900 may include causing the prompt to be passed to the language model for processing. The prompt may be passed to the language model in response to a determination that processing of the prompt by the language model does not violate the applicable data control policy. In various implementations, causing the prompt to be passed to the language model may include notifying a client service operating as an intermediate layer that the processing of the prompt by the language model does not violate the applicable data control policy.

Procedure 900 then ends at step 930.

It should be noted that while certain steps within procedure 900 may be optional as described above, the steps shown are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduce prompt processing units facilitating a mechanism to characterize and distill key features from a prompt in a systematic manner. These characterizations/distillations may then be leveraged to provide extensive data control mechanisms capable of extending data control downstream in a manner not previously achievable.

For example, these techniques empower enterprises and other users to define, apply, and manage rules enabling data controls working in tandem with a PPU, with focus on controlling sensitive data processing, data leakage and misuse. Moreover, these techniques facilitate detection of data control infringements to such rules in real-time, by applying targeted similarity search in a confined space. For instance, these techniques enable the detection of data control infringements including infringements to consented purpose of use of the data, data minimization rules, relative geo-location between the client and the data processor (e.g., the LLM instance), output data transfers, and/or retrieval of augmented context before a prompt is sent to a third party.

These techniques may be applied at various stages of model utilization, including real-time operation, initial learning stages, and during refinement of model parameters. They are compatible with a range of platforms and services such as network management interfaces for API communication, proprietary gateways for secure data exchange, anticipated enterprise inference platforms, external computational systems specializing in predictive analytics, tools for overseeing data compliance and usage, systems for preventing data loss, collaborative frameworks involving computational model providers, centralized portals for integrating various API services, etc.

In addition these techniques provide for increased trust and higher accuracy, as the better understanding and detection capability of PPUs enhances sensitive data protection. Further, these techniques drive faster adoption of generative AI by providing increased confidence to leverage third party LLMs thanks to stronger detection and data controls. Furthermore, these techniques facilitate and enhance visibility and auditability, empowering enterprises and other users to keep track of prompts, detections made, applied controls, etc. Moreover, these techniques deliver enhanced controls by providing the ability to manage multiple policies and controls concurrently in large-scale and varied environments with ever evolving generative AI use cases. These techniques deliver a solution that offers seamless integration with existing systems. For instance, the open architecture of these techniques enhances enterprise and/or other investments with generative AI specific controls, avoiding disruptive system overhauls or reinventing the wheel. In short, these techniques deliver collaboration and alignment by providing IT, data, privacy, security, operations, etc. teams with a uniform means to define, consult, and manage generative AI policies.

Further, these techniques may be leveraged to dynamically manage data controls such as by selectively applying, disabling, or bypassing them. For example, characterizations provided by the PPU may be utilized to trigger the appropriate data controls when specific data is necessary to complete a task from a prompt or partially or fully disable or bypass the data controls where specific data is not necessary to complete the task. This adaptive approach may allow a prompt processing pipeline to selectively apply controls based on the actual needs of each prompt, avoiding unnecessary processing. As a result, substantial resource savings-such as computational power, energy, time, and costs-can be achieved without compromising the quality and reliability of data control. By leveraging the PPU's prior characterization, the system can also avoid unnecessary delays and resource consumption associated with scanning policy matrices for every prompt.

While there have been shown and described illustrative implementations that provide for data controls using prompt processing units, it is to be understood that various other adaptations and modifications may be made within the spirit and scope of the implementations herein. For example, while certain implementations are described herein with respect to using certain elements, modules, components, architectures, etc. for the purposes of data control, the elements, modules, components, architectures, etc. are not limited as such and may be used for other functions, in other arrangements, in other functional distributions, in other implementations, etc. In addition, while certain types of metadata and data types/categories such as tasks, sensitive data, constraints, and outputs are shown, other suitable metadata and data types/categories may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
identifying, by a device, features of a prompt to be sent to a language model that are indicative of a type of data that the prompt would cause the language model to access;
determining, by the device, whether data control policies apply for the prompt based on the type of data that the prompt would cause the language model to access;
determining, by the device and based on the features, whether processing of the prompt by the language model violates an applicable data control policy; and
preventing, by the device, the language model from processing the prompt when the processing of the prompt violates the applicable data control policy.

2. The method of claim 1, further comprising:
identifying the applicable data control policy by a similarity search of a repository of data control policy matrices for a data control policy that corresponds to the features of the prompt.

3. The method of claim 1, further comprising:
identifying the applicable data control policy by its correspondence to an identification associated with a submitter of the prompt.

4. The method of claim 1, wherein preventing the language model from processing the prompt includes blocking the prompt from being provided to the language model for processing.

5. The method of claim 1, wherein preventing the language model from processing the prompt includes filtering a portion of the prompt from being provided to the language model for processing.

6. The method of claim 1, wherein preventing the language model from processing the prompt includes flagging the prompt for reengineering prior to being provided to the language model for processing.

7. The method of claim 1, further comprising:
causing the prompt to be passed to the language model for processing responsive to a determination that processing of the prompt by the language model does not violate the applicable data control policy.

8. The method of claim 7, wherein causing the prompt to be passed to the language model includes notifying a client service operating as an intermediate layer that the processing of the prompt by the language model does not violate the applicable data control policy.

9. The method of claim 1, wherein control over the prompt is retained by an intermediate layer while determining whether the processing of the prompt by the language model violates the applicable data control policy.

10. The method of claim 9, further comprising:
parsing the prompt to automatically identify the features of the prompt, wherein the features of the prompt are further indicative of one or more of a task requested in the prompt, a constraint applicable to completing the task, or an expected output on completion of the task; and
providing the features of the prompt as metadata associated with the prompt for comparison to data control policies.

11. An apparatus, comprising:
one or more network interfaces to communicate with a network;
a processor coupled to the one or more network interfaces and configured to execute one or more processes; and
a memory configured to store a process that is executable by the processor, the process, when executed, configured to:
identify features of a prompt to be sent to a language model that are indicative of a type of data that the prompt would cause the language model to access;
determine whether data control policies apply for the prompt based on the type of data that the prompt would cause the language model to access;
determine, based on the features, whether processing of the prompt by the language model violates an applicable data control policy; and 13 prevent the language model from processing the prompt when the processing of the prompt violates the applicable data control policy.

12. The apparatus as in claim 11, the process further configured to:
identify the applicable data control policy by a similarity search of a repository of data control policy matrices for a data control policy that corresponds to the features of the prompt.

13. The apparatus as in claim 11, the process further configured to:
identify the applicable data control policy by its correspondence to an identification associated with a submitter of the prompt.

14. The apparatus as in claim 11, wherein preventing the language model from processing the prompt includes blocking the prompt from being provided to the language model for processing.

15. The apparatus as in claim 11, wherein preventing the language model from processing the prompt includes filtering a portion of the prompt from being provided to the language model for processing.

16. The apparatus as in claim 11, wherein preventing the language model from processing the prompt includes flagging the prompt for reengineering prior to being provided to the language model for processing.

17. The apparatus as in claim 11, the process further configured to:
cause the prompt to be passed to the language model for processing responsive to a determination that processing of the prompt by the language model does not violate the applicable data control policy.

18. The apparatus as in claim 17, wherein causing the prompt to be passed to the language model includes notifying a client service operating as an intermediate layer that the processing of the prompt by the language model does not violate the applicable data control policy.

19. The apparatus as in claim 11, wherein control over the prompt is retained by an intermediate layer while determining whether the processing of the prompt by the language model violates the applicable data control policy.

20. A tangible, non-transitory, computer-readable medium having computer-executable instructions stored thereon that, when executed by a processor on a computer, cause the computer to perform a method comprising:
identifying features of a prompt to be sent to a language model that are indicative of a type of data that the prompt would cause the language model to access;
determining whether data control policies apply for the prompt based on the type of data that the prompt would cause the language model to access;
determining, based on the features, whether processing of the prompt by the language model violates an applicable data control policy; and
preventing the language model from processing the prompt when the processing of the prompt violates the applicable data control policy.
